(19) United States
(12) Patent Application Publication
(10) Pub. No.: US 2014/0338302 A1
(43) Pub. Date: Nov. 20, 2014

(54) End Weighted Mower Blade

(71) Applicant: Charles Ernest Daffin, Tallahassee, FL (US)

(72) Inventor: Charles Ernest Daffin, Tallahassee, FL (US)

(21) Appl. No.: 13/895,970

(22) Filed: May 16, 2013

(51) Int. Cl. A01D 34/73

(52) U.S. Cl. CPC A01D 34/73
USPC 56/289

(57) ABSTRACT

A mower blade generally comprised of a rotor which connects to the mower at an attachment point and at least one outer end of the rotor, wherein the outer end or ends of the rotor are heavier than the rotor proximate the attachment point. The added weight to the outer end can be by way of an extension or an end section.

### CROSS-REFERENCES TO RELATED APPLICATIONS

This application is a continuation in part of prior pending application U.S. Ser. No. 13/346,559 filed on Jan. 9, 2012, which was a continuation in part of U.S. Ser. No. 12/660,005 filed on Feb. 19, 2010.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of mower blades. More specifically, to the weigh or mass distribution of the blades center compared to the blades outermost end.

2. Description of the Related Art

When mower blades are new, they provide a clean and quick cut. After repeated uses and wear, the blade starts to loose mass or weight on the outer end. Additionally, repeated sharpening of the blade contributes to the loss of mass on the cutting edge, which is the outermost end of the blade. As the blade end loses mass or weight, it becomes less efficient at cutting and eventually has to be replaced with a new, unworn, blade.

Therefore what is needed is a mower blade that does not lose its cutting efficiency after wear from use and sharpening. And such remedy would also increase the cutting power of the blade. The present invention achieves this objective, as well as others that are explained in the following description.

### BRIEF DESCRIPTION OF THE DRAWINGS

A complete, understanding of the present invention may be obtained by reference to the accompanying drawings, when considered in conjunction with the subsequent, detailed description in which:

FIG. 1A is a top plan view of a prior part standard mower blade;

FIG. 1B is a top plan view of prior art standard mower blade with a worn down prior art cutting edge;

FIG. 2 is a perspective view showing the present invention:

FIG. 3 is a perspective view showing the present invention with a worn down cutting edge worn;

FIG. 4 is a perspective view showing an alternate embodiment of the present invention;

FIG. 5 is a top plan view showing an alternate embodiment of the present invention;

FIG. 6 is a top plan view showing an alternate embodiment of the present invention an extended outer cutting edge;

FIG. 7 is a perspective view of a prior art standard mower blade;

FIG. 8 is a perspective view showing the present invention;

FIG. 9 is a perspective view showing the present invention;

FIG. 10 is a perspective view showing to present invention from underneath the blade;

REFERENCE NUMERALS IN THE DRAWINGS

| | | | |
|---|---|---|---|
| 10 | present blade | 12 | prior art rotor |
| 14 | prior art center | 16 | extension |
| 20 | prior art outer cutting edge | 28 | prior art outer end |
| 30 | outer cutting edge | 32 | rotor |
| 34 | attachment point | 36 | rotor |
| 38 | first outer end | 44 | second outer end |
| 46 | upper surface | 48 | lower surface |
| 50 | section | | |

### DETAILED DESCRIPTION OF THE INVENTION

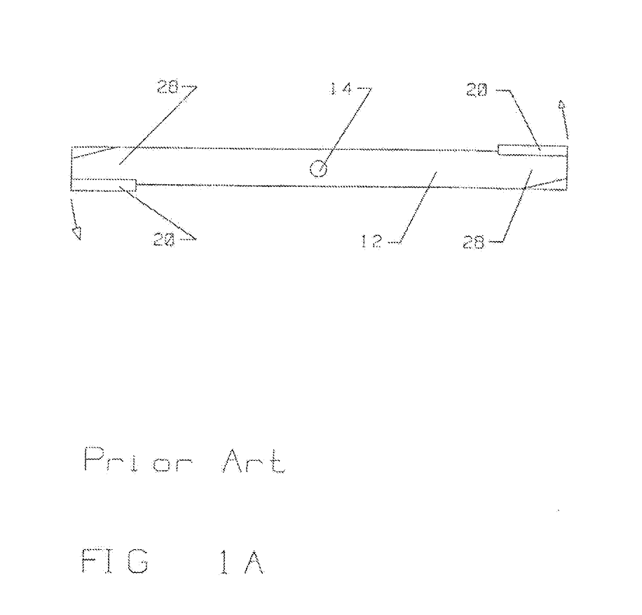

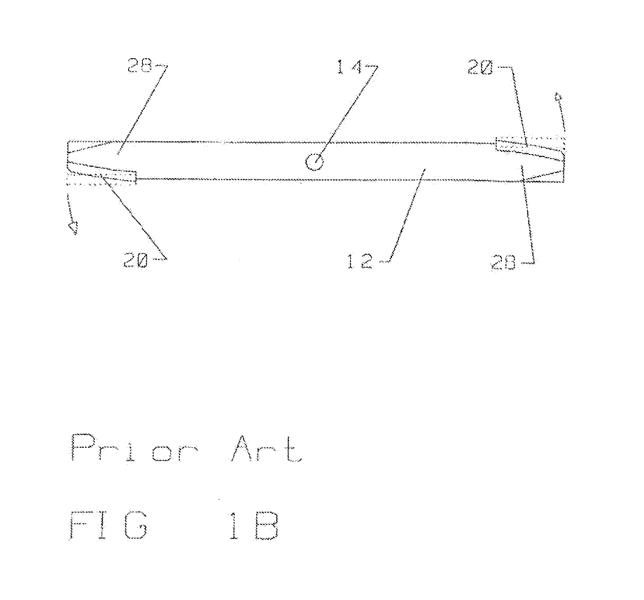

FIG. 1A is a top plan view, showing a prior art standard mower blade. FIG. 1B is also a top plan view showing a prior art standard mower blade with a worn away outer cutting edge. FIGS. 1A and 1B are prior art mower blades showing prior art attachment point 14, prior art rotor 12 and prior art outer cutting edge 20 on prior art outer end 28. In the prior art standard mower blade the prior art rotor 12 has basically the same size throughout. This includes the same thickness and width from prior art attachment point 14 to prior art outer end 28 at prior art outer cutting edge 20. Some blades do have minor shape changes but not enough to be relevant to a substantial increase in mass on prior all outer end 28. As illustrated in FIG. 1B, prior art outer cutting edge 20 is worn down. The wearing away of the prior art cutting edge 20 has reduced the mass on the outer cutting edge 20, causing a significant decrease in cutting potential. Due to the decrease in mass, the energy delivered is now less, which equals less damage to the object being cut. This kind of wear on a standard blade 12 could greatly reduce its cutting efficiency.

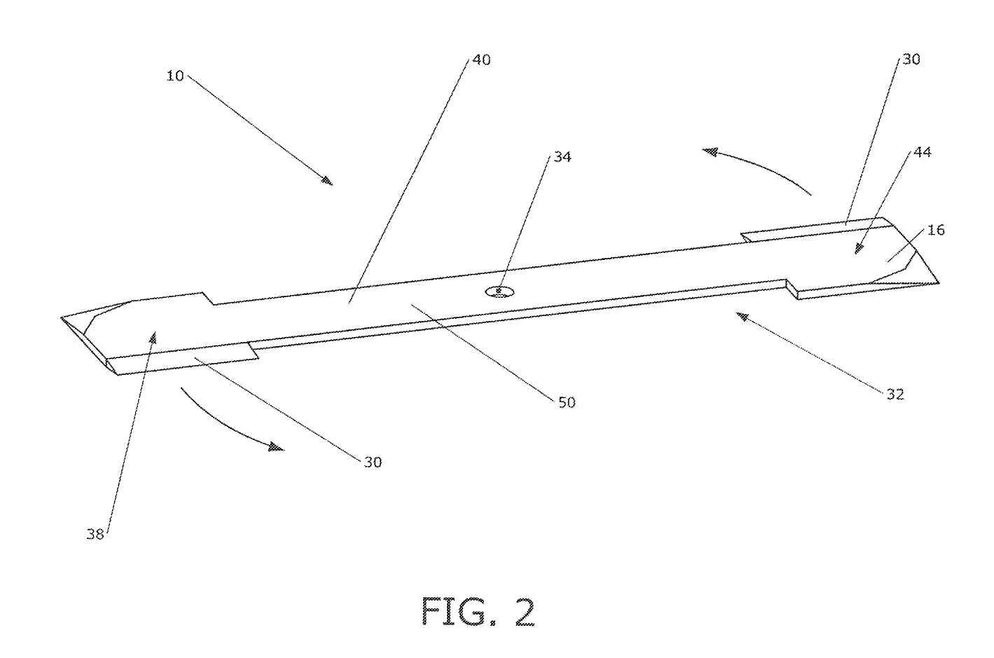

FIG. 2 shows the present invention. The blade 10 consists of a rotor 32 with added or increased weight or mass, shown as extension 16 on outer end 38 of rotor 32. The added or increased weight provided by extension 16 generates more energy to the object(s) being cut even where the speed at which the rotor spins remains constant. Rotor 32 comprises a section 50 and at least one outer end 38. In FIG. 2, a first outer end 38 and a second outer end 44 are integrated with section 50 on either end. As will be further explained herein, each outer end 38, 44 has substantially more mass than section 50. The illustrative arrows show the direction of rotation for the blade 10. The mower blade 10 is such that blade 10 attaches at attachment point 34 to a blade mounting system on a mower for use. As the blade 10 rotates, outer cutting edges 30 slice through grass at the specific set distance above the ground.

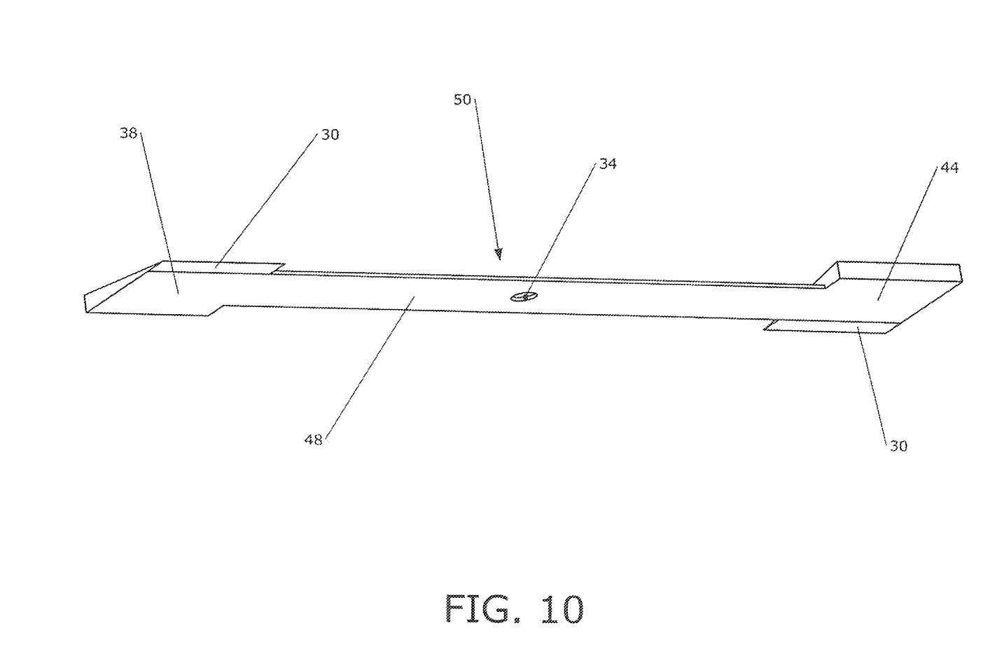

Rotor 32 has an upper surface 46 and a lower surface 48, which is shown in FIG. 10. Returning to FIG. 2, upper surface 46 and lower surface 48 of rotor 32 lie within the same horizontal planar surface (visible as to lower surface FIG. 10). The reader will appreciate that extension 16 shares a lower surface and upper surface with section 50 and therefore first outer end 38 and second outer end 44 do not generate unnecessary drag as it spins through the air.

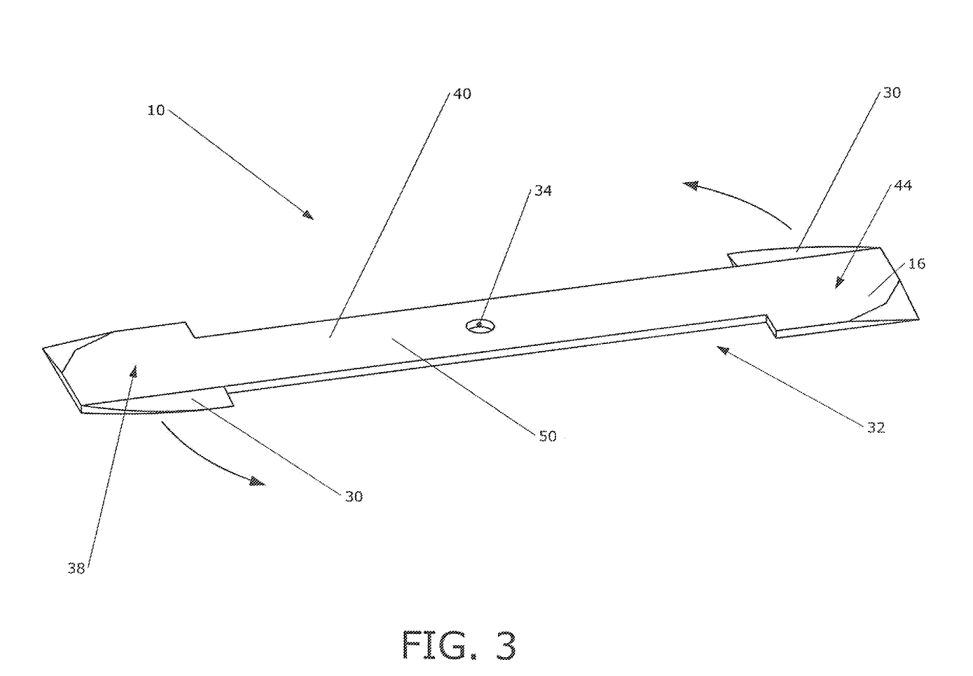

FIG. 3 shows the present invention with a worn down outer cutting edge 30. Outer end 38 with cutting edge 30 has substantial added or increased weight or mass, shown here as extension 16, that the loss from wear is insignificant. Even with the worn away outer cutting edge 30, the present blade will still do damage and will not have to be replaced. Again, the arrows at the outer end 38 show the direction of rotation. Extension 16 extends off of outer end 38 of present blade 10 and remains on the same plane as rotor 32. It is important that the blade remains streamlined such that it does not produce additional drag as it travels through the air.

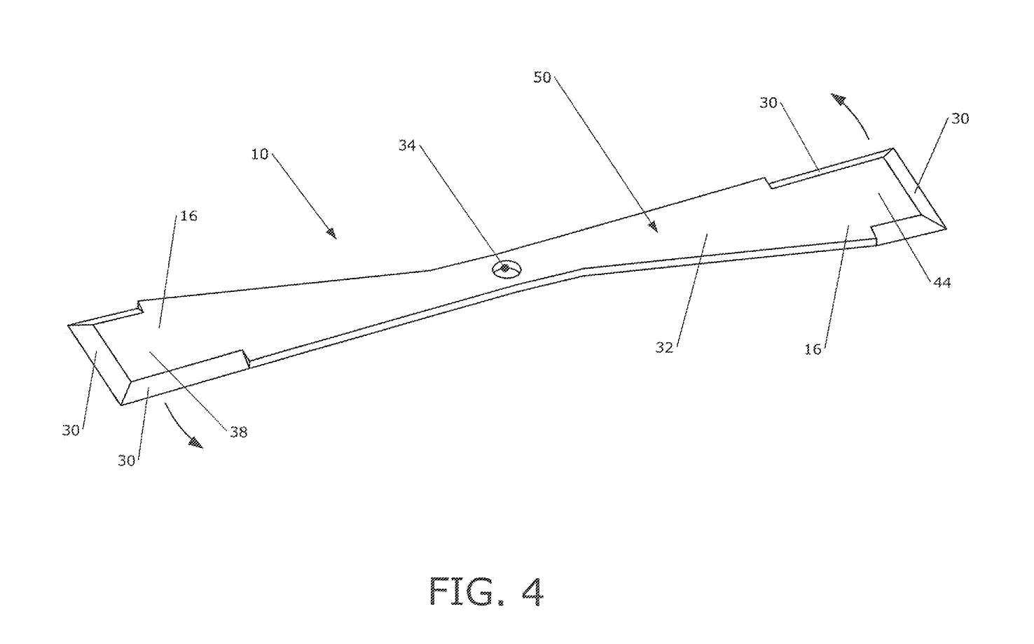

FIG. 4 illustrates the present blade 10 in a slightly different shape which, by design, includes greater weight or mass to first outer end 38 of rotor 32 and second outer end 44 as opposed to section 50 of rotor 32. Again, the blade 10 is designed such that first outer end 38 is substantially more mass than section 50 and second outer end 44 is substantially more mass than section 50. As such, the blades 30 can cut effectively even when worn away. As described above, upper surface and lower surface of the blade are within the same horizontal planar surface (as illustrated in FIGS. 2 and 3). While all of the blades shown are designed as a particular shape, the present invention should not be limited to the shapes shown.

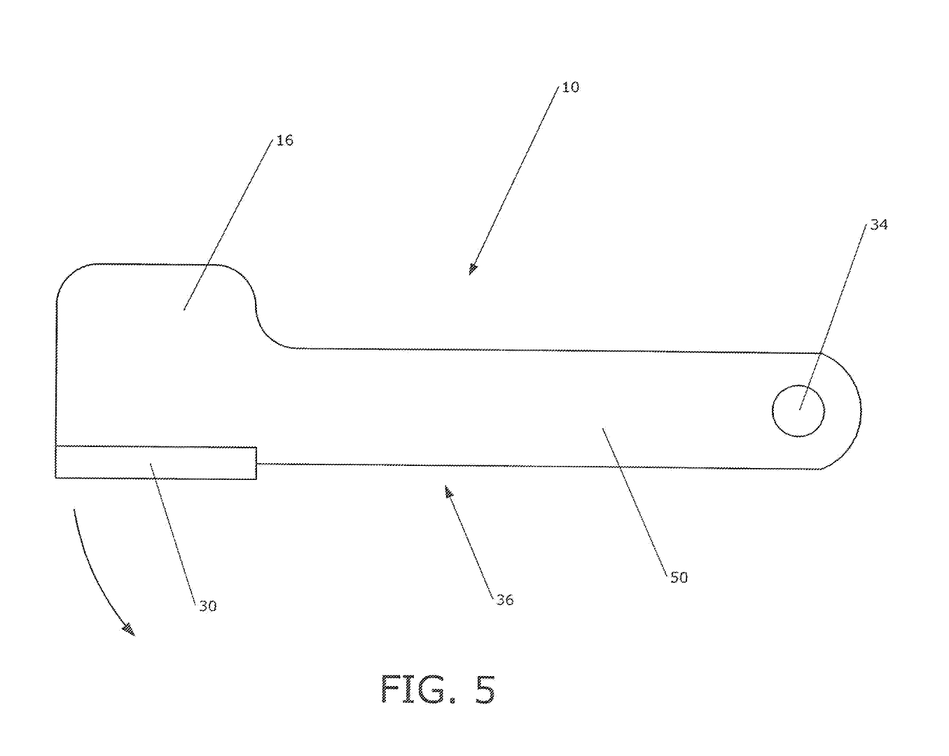

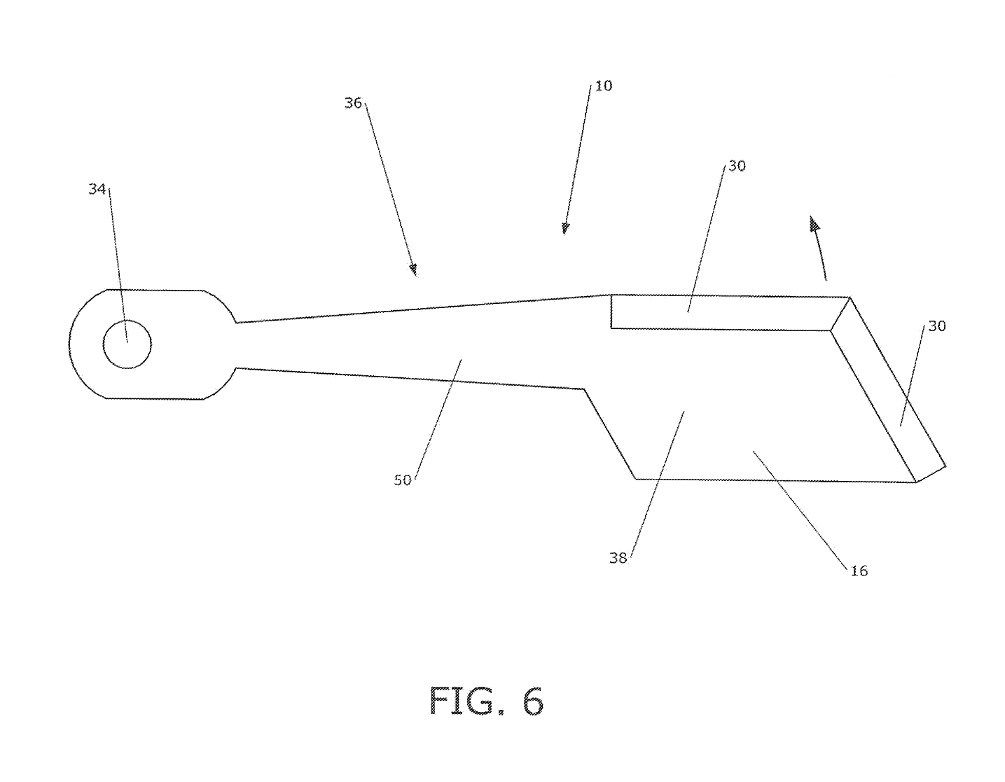

FIGS. 5 and 6 show a top plan view of blades for “bush-hog” type mowers. In FIGS. 5 and 6 extensions 16 are located on a first outer end 38 for the purpose of adding weight to the outer end 38 of rotor 36. The weight distribution on rotor 36 is such that first outer end 38 has a significantly greater weight than section 50. Rotor 36 has an upper surface and a lower surface. Outer end 38 and section 50 share the upper surface and lower surface of rotor 36. Therefore, upper surface and lower surface of rotor resides in the same horizontal plane as outer end 38 and section 50. No additional drag is created by the rotation of the blades 10 when the rotor surfaces lie within the same plane.

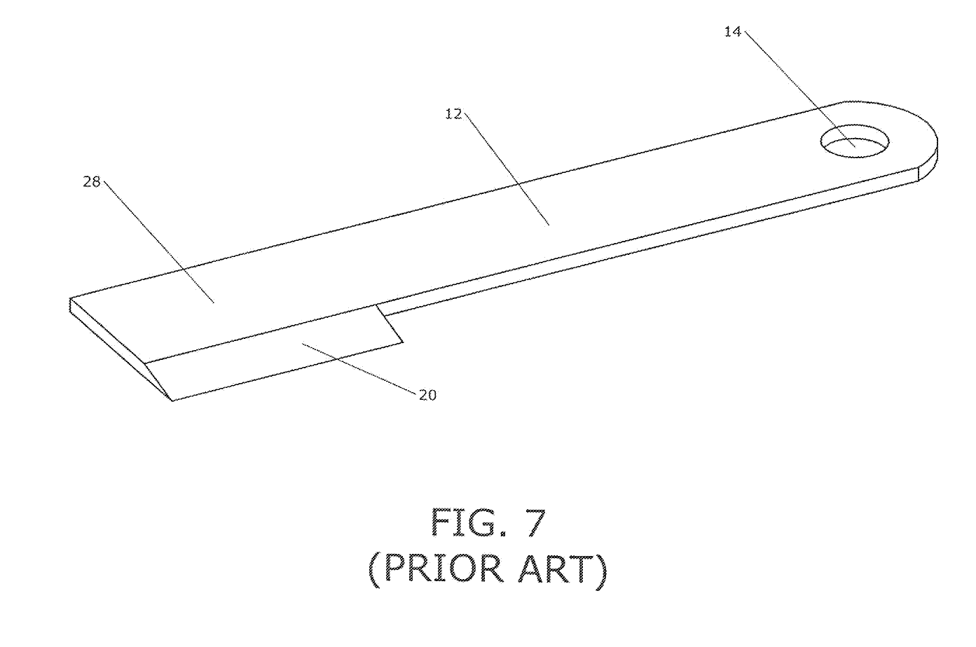

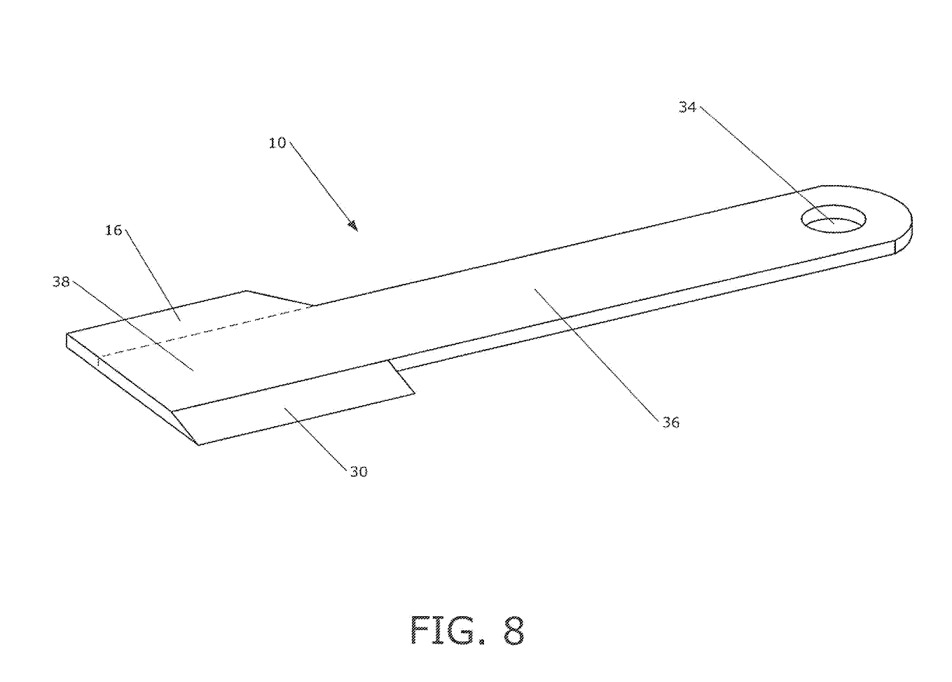

FIG. 7 is a perspective view of a prior art standard blade 12. Standard blade 12 is uniform in weight distribution from prior of attachment point 14 to prior art outer end 28. The present invention, shown in FIG. 8. creates more mass on outer end 38 by increasing blade width with the addition of extension 16 which lies in the same plane as rotor 36. The additional weight increases the energy to be delivered by outer cutting edge 30 upon an external object, such as grass. As illustrated, the outer third section of rotor 36 (or the first outer end 38) is a greater weight than inner two-thirds of the rotor 36.

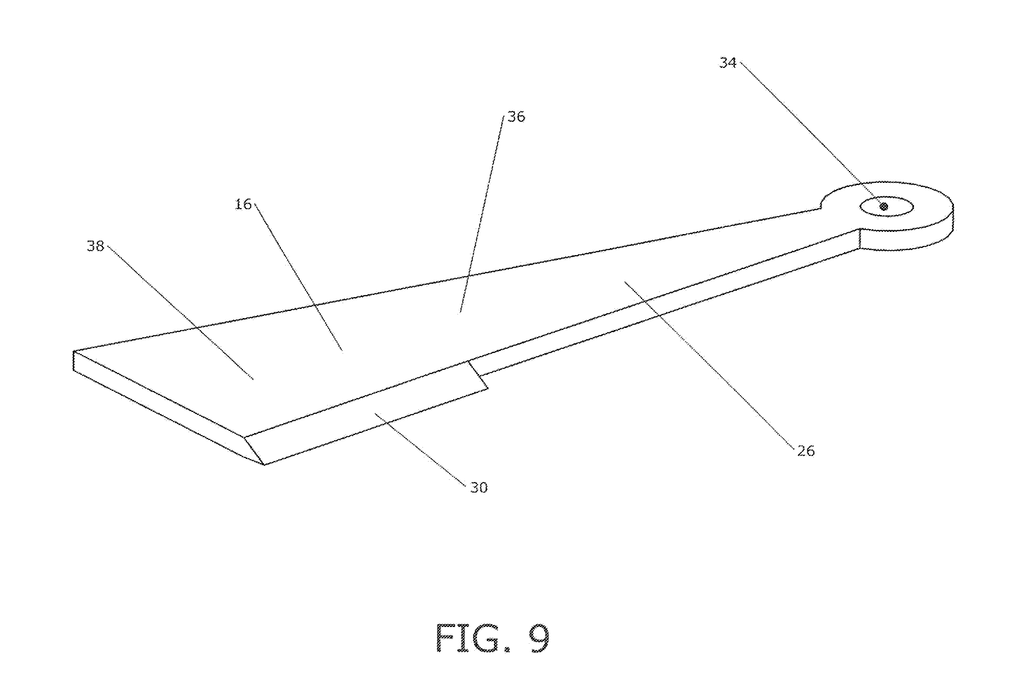

An alternate embodiment of the present invention is shown in FIG. 9. Again, the first outer end 38 is heavier than the remainder of the rotor 36 due to the design of the blade. All sections of the rotor 36 lie in the same horizontal plane.

The lower surface 48 of rotor 32 is illustrated in FIG. 10. Each section of rotor 32 lies in the same horizontal plane as the lower surface 48 of rotor 32. Thus, the blade maintains a consistent lower surface 48 which does not create drag or opposing forces. Section 50 is less weight than first outer end 38 and second outer end 44.

Since other modifications and changes varied to fit particular operating requirements and environments will be apparent to those skilled in the art, the invention is not considered limited to the example chose for purposes of disclosure, and covers all changes and modifications which do not constitute departures from the scope of this invention.

1. A mower blade for use on a lawn mower having a blade mounting system, comprising:
a. a rotor having an attachment point, an upper surface and a lower surface;
b. wherein said rotor further comprises;
i. at least one outer end of said rotor;
ii. a section proximate to said at least one outer end of said rotor housing said attachment point;
c. wherein said lower surface of said rotor lies within a single horizontal plane;
d. wherein said at least one outer end further comprises:
i. a cutting edge: and
ii. an extension.

2. The mower blade of claim 1, wherein said at least one outer end has a weight, wherein said weight of said at least one outer end is greater than said section of said rotor.

3. The mower blade of claim 1, wherein said outer end of said rotor has a width that is greater than said width of said rotor at said attachment point.

4. The mower blade of claim 1, wherein said at least one outer end of said rotor has a weight that is greater than said weight of said rotor at said attachment point.

5. The mower blade of claim 2, wherein an end section is attached to said extension at said at least one outer end of said rotor.

6. A mower blade for use on a lawn mower having a blade mounting system, comprising:
a. a rotor having an attachment point, all upper surface and a lower surface;
b. wherein Said rotor further comprises:
i. a first outer end of said rotor;
ii. a second outer end of said rotor; and
ii. a section between said first outer end and said second outer end of said rotor housing said attachment point;
c. wherein said lower surface of said rotor lies within a single horizontal plane;
d. wherein said first and second outer end further comprises;
i. a cutting edge; and
ii. an extension.

7. The mower blade of claim 6, wherein said first outer end has a weight, wherein said weight of said first outer end is greater than said section of said rotor.

8. The mower blade of claim 7, wherein said second outer end has a weight, wherein said weight of said second outer and is greater than said section of said rotor.

9. A mower blade, comprising:
a. a rotor having an attachment point, an upper surface and a lower surface;
b. wherein said rotor further comprises:
i. a first outer end of said rotor;
ii. a second outer end of said rotor; and
ii. a section between said first outer end and said second outer end of said rotor housing said attachment point;
c. wherein said upper surface of said rotor lies within a single horizontal plane;
d. wherein said lower surface of said rotor lies within a single horizontal plane;
e. wherein said first and second outer end further comprises:
i. a cutting edge; and
ii. an extension.

10. The mower blade of claim 9, wherein said first outer end has a weight, wherein said weight of said first outer end is greater than said section of said rotor.

11. The mower blade of claim 10, wherein said second outer end has a weight, wherein said weight of said second outer end is greater than said section of said rotor.

12. The mower blade of claim 9, further comprising a second outer cutting edge angularly displaced from said first outer cutting edge.
